(19) United States
(12) Patent Application Publication
(10) Pub. No.: US 2007/0236611 A1
(43) Pub. Date: Oct. 11, 2007

(54) Method of Quickly Selecting a Television Channel and Related Video Device

(76) Inventors: Tson-Yee Lin, Taipei City (TW); Chen-Cheng Chiang, Tai-Chung City (TW); Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/279,395

(22) Filed: Apr. 11, 2006

(51) Int. Cl. H04N 9/74; H04N 5/50

(52) U.S. Cl. 348/731; 348/588

(57) ABSTRACT

A method of selecting a television channel on a video device having a television tuner includes displaying a currently selected channel on the video device, controlling the video device to simultaneously display the currently selected channel and a plurality of other channels that are not currently selected, each of the displayed channels showing moving images corresponding to the content broadcast on the respective channels, wherein channel numbers of the currently selected channel and the plurality of other channels that are not currently selected conform to a predefined pattern, changing the channel on the video device to select one of the displayed channels that was not previously selected, the newly selected channel becoming the currently selected channel, and simultaneously displaying the currently selected channel and a plurality of other channels that are not currently selected.

### BACKGROUND OF THE INVENTION

1. Field of the Invention

The present invention relates to a video device having a television tuner and a method of quickly selecting a television channel on the video device.

2. Description of the Prior Art

In recent times, television has widely grown in popularity. As a result, more television channels are available for viewing, such as through cable television or through satellite television. With the higher number of television channels available for viewing, it can become harder for television viewers to find the show that they would most like to watch out of those available.

Please refer to FIG. 1. FIG. 1 shows a display status 10 of a prior art television. The display status 10 shows a single channel, which is indicated as channel number 75. Typically, if the user wishes to see what other programs are available, the user must change the channel to see what is being broadcast on other channels. To change the channel, the user can a channel up or channel down button or can press number buttons located on the remote control. In either case, only one television show can be seen at a time by changing the channel to the appropriate number.

Often, television channels that show similar types of content are grouped together in a small range of channel numbers. For instance, the news channels might all be grouped from channels 50-55, the sports channels might be grouped together from channels 72-75, and so on. Grouping channels in this way makes it easier for viewers to quickly find a program to watch according to the program category. Suppose that a user wishes to watch a sports channel in the range of channels 72-75, and the user cannot remember exactly which channel number is the channel he would like to watch or the user would like to see what is being shown on all of the sports channels. In this situation, the user has to select one of the channel numbers in the range of channels 72-75 and keep flipping through the channels until he finds what he would like to watch. Unfortunately, the user is limited to seeing one channel at a time when viewing the broadcast programs. Being able to view only one program at a time makes it slow and inconvenient to search through channels to see what is showing.

### SUMMARY OF THE INVENTION

It is therefore an objective of the claimed invention to provide a method and video device to allow improved television channel searching in order to solve the above-mentioned problems.

According to an exemplary embodiment of the claimed invention, a method of selecting a television channel on a video device having a television tuner is disclosed. The method includes displaying a currently selected channel on the video device, controlling the video device to simultaneously display the currently selected channel and a plurality of other channels that are not currently selected, each of the displayed channels showing moving images corresponding to the content broadcast on the respective channels, wherein channel numbers of the currently selected channel and the plurality of other channels that are not currently selected conform to a predefined pattern, changing the channel on the video device to select one of the displayed channels that was not previously selected, the newly selected channel becoming the currently selected channel, and simultaneously displaying the currently selected channel and a plurality of other channels that are not currently selected, wherein the channel numbers of the currently selected channel and the plurality of other channels that are not currently selected conform to the predefined pattern.

According to another exemplary embodiment of the claimed invention, a video device for selecting a television channel is disclosed. The video device includes a display unit, a television tuner for displaying television channels on the display unit, a processor for controlling the television tuner to simultaneously display a currently selected channel and a plurality of other channels that are not currently selected, each of the displayed channels showing moving images corresponding to the content broadcast on the respective channels, wherein channel numbers of the currently selected channel and the plurality of other channels that are not currently selected conform to a predefined pattern, and a channel selection unit for changing the channel on the video device to select one of the displayed channels that was not previously selected, the newly selected channel becoming the currently selected channel.

It is an advantage of the claimed invention that the user can quickly see what is showing on more than one channel while searching through television channels and select a channel more quickly than in the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a display status of a prior art television.

FIG. 2 illustrates a block diagram of a present invention video device.

FIG. 3 and FIG. 4 show a currently selected channel and unselected channels arranged in vertical and horizontal orientations according to the present invention.

FIG. 5 shows switching channels while in a multiple channel view.

FIG. 6 shows confirming selection of a currently selected channel.

FIG. 7 illustrates displaying multiple unselected channels at once according to another embodiment of the present invention.

FIG. 8 is a flowchart showing the method of selecting television channels according to the present invention.

### DETAILED DESCRIPTION

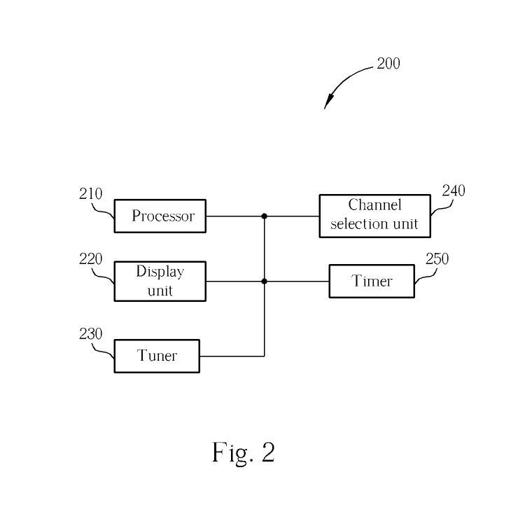

Please refer to FIG. 2, which illustrates a block diagram of a present invention video device 200. The video device 200 comprises a processor 210 for controlling operation of the video device 200, a tuner 230 for receiving television channels, a display unit 220 for showing the channels received by the tuner 230, a channel selection unit 240 for allowing a user to select different channels, and a timer 250 for measuring the amount of time that the user has not input any commands to the video device 200. The video device 200 is not limited to being a television, but can also include a videocassette recorder (VCR), a digital versatile disc (DVD) player, a computer TV card, or any other device with a television tuner.

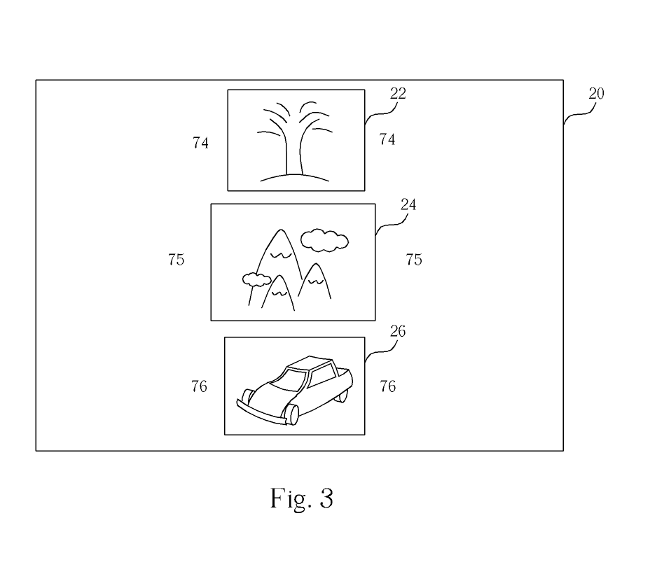

Please refer to FIG. 3. FIG. 3 shows a display status 20 of the video device 200 according to the present invention. The display status 20 shows a currently selected channel 24 corresponding to channel number 75, a first unselected channel 22 corresponding to channel number 74, and a second unselected channel 26 corresponding to channel number 76. The channel numbers corresponding to the currently selected channel 24 and the unselected channels 24, 26 are consecutive numbers.

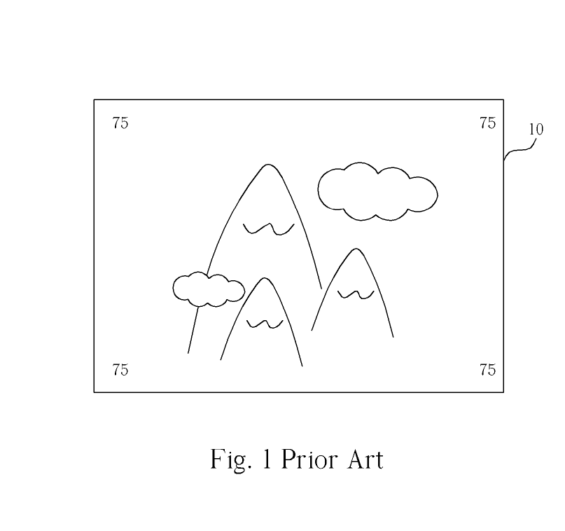

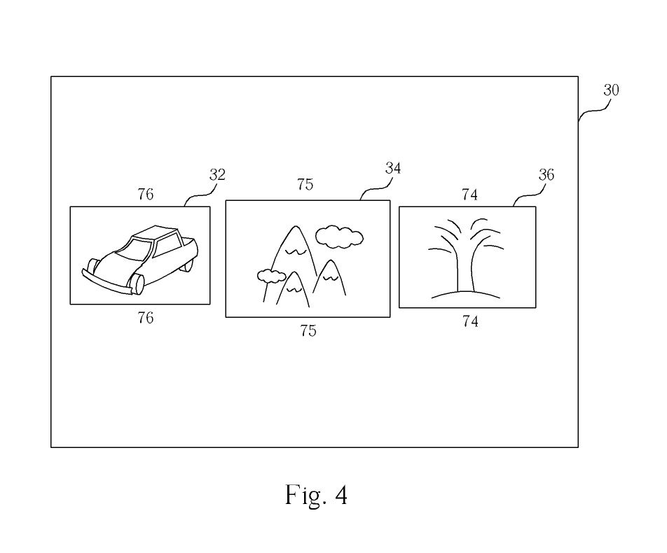

When first turning on the video device 200, a single channel is displayed, such as what is shown in the display status 10 of FIG. 1. The user can change the channel to another channel by pressing the channel up button, the channel down button, or one of the number buttons located on the channel selection unit 240, such as on a remote control. The present invention offers the ability to see the live broadcast of more than one channel at a time to help the user more quickly decide which program to watch. Suppose while the video device 200 has the display status 10 shown in FIG. 1, the user presses a “multiple channel view” button on the remote control. This brings up the display status 20 shown in FIG. 3. Since channel number 75 was previously selected, channel number 75 is also shown as the currently selected channel 24 in FIG. 3, with channel numbers 74 and 76 being unselected channels 22, 26. Both the currently selected channel 24 and the unselected channels 22, 26 show moving images corresponding to the programs currently being broadcast on those channels. FIG. 3 shows how the channels can be arranged in a vertical orientation, whereas FIG. 4 shows another display status 30 with currently selected channel 34 and unselected channels 32, 36 being arranged in a horizontal orientation.

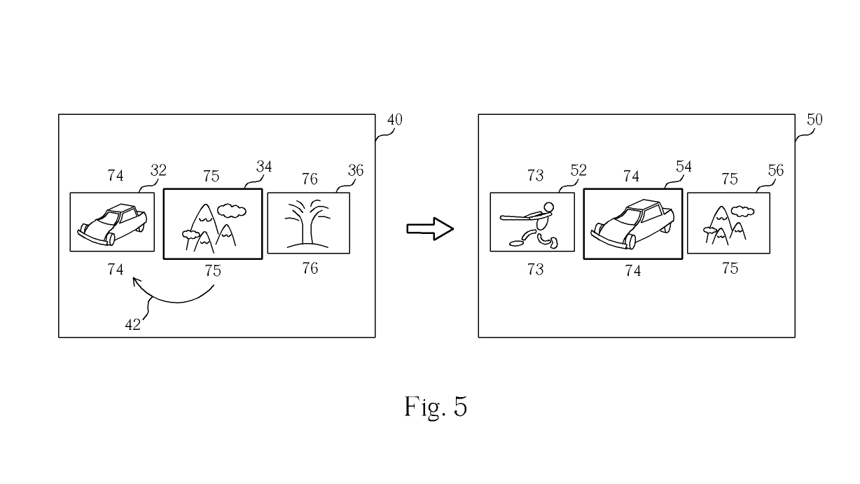

Please refer to FIG. 5, which shows the action of switching channels while in a multiple channel view. Arrow 42 indicates that the user is pressing a button on the channel selection unit 240 to go from the currently selected channel 34 of channel number 75 to the unselected channel 32 of channel number 74. This channel change can be made, for example, by pressing the channel down button, a left arrow button, or a down arrow button on the channel selection unit 240. As a result, what is being shown on the display unit 220 changes from display status 40 to display status 50. In display status 50, channel number 74 is shown as currently selected channel 54, and channel numbers 73 and 75 are shown as unselected channels 52, 56. The channel can be changed further by pressing channel up or down buttons, arrow buttons, or number buttons.

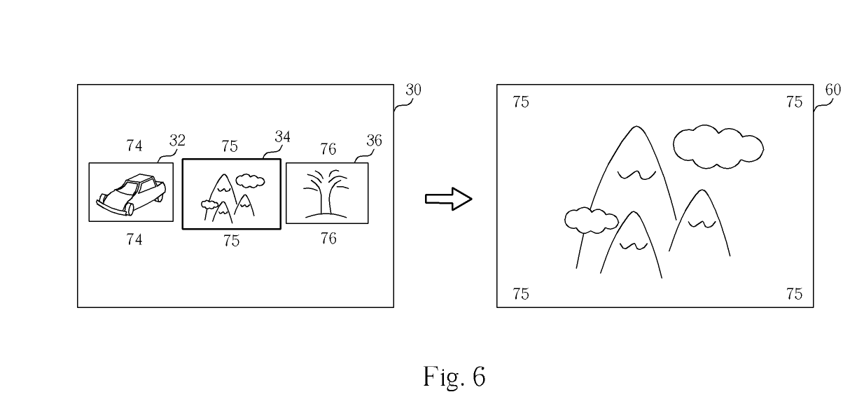

Please refer to FIG. 6, which shows the action of confirming selection of currently selected channel 34. If the currently selected channel 34 corresponds to channel number 75 and a users presses a button on the channel selection unit 240 confirming the selection of the currently selected channel 34, the currently selected channel 34 will be shown in full screen mode, as is illustrated in display status 60. This completes the channel selection process.

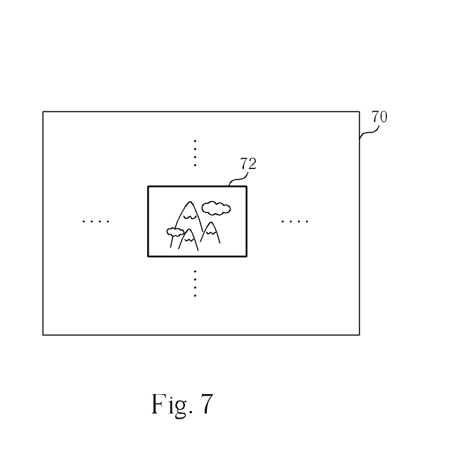

As shown in FIG. 7, display status 70 indicates that multiple channels can be shown at once according to another embodiment of the present invention. Currently selected channel 72 can be surrounded by many unselected channels on the left, right, top, or bottom of the currently selected channel 72, or any combination of these sides. The number of channels that can be displayed at once is limited only by the processing power of the processor 210 since displaying multiple moving screens at one time is requires intensive calculations to be performed by the processor 210. Thus, instead of only two unselected channels being shown at any one time, many unselected channels can be shown instead, thereby giving the user the ability to see more channels at the same time for quickly selecting a channel.

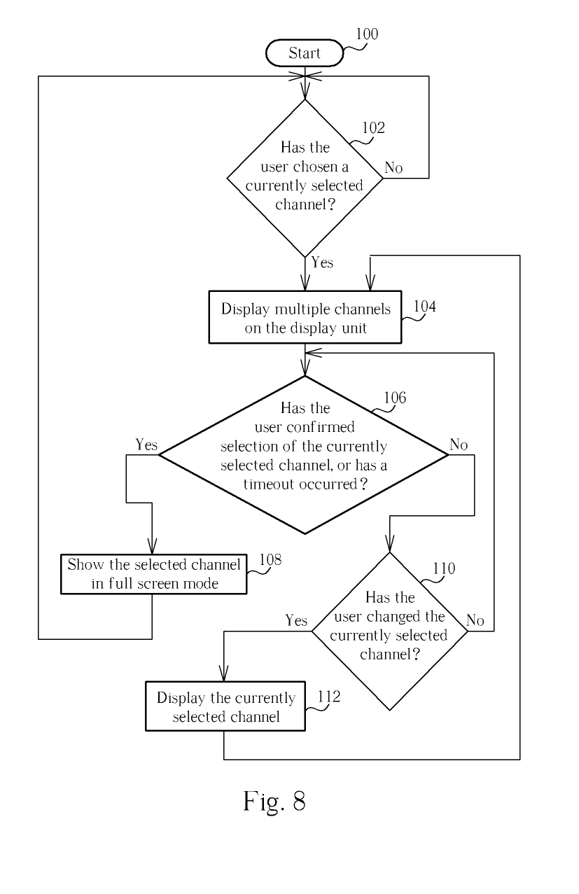

Please refer to FIG. 8. FIG. 8 is a flowchart showing the method of selecting television channels according to the present invention. Steps contained in the flowchart will be explained below.

Step 100: Start.

Step 102: Determine if the user has chosen a currently selected channel. If so, go to step 104. If not, repeat step 102.

Step 104: Press the multiple channel view button on the channel selection unit 240 to display multiple channels on the display unit 220, including one currently selected channel and a plurality of unselected channels.

Step 106: While displaying multiple channels, determine if the user has either confirmed selection of the currently selected channel or has not input control signals through the channel selection unit 240 for a predetermined period of time, thereby causing a timeout situation. If so, go to step 108. If not, go to step 110.

Step 108: Show the selected channel on the full screen of the display unit 220. Go back to step 102.

Step 110: Determine if the user has pressed control signals through the channel up/down buttons, arrow buttons, or number buttons on the channel selection unit 240 for changing the currently selected channel. If so, go to step 112. If not, go back to step 106.

Step 112: Display the currently selected channel on the display unit 220. Go back to step 104.

In summary, the present invention allows the user to see more than one channel at a time, which enables the user to select a channel more quickly than in the prior art. The present invention is especially useful when the user would like to look through all channels in a range of numbers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of selecting a television channel on a video device having a television tuner, the method comprising:
displaying a currently selected channel on the video device;
controlling the video device to simultaneously display the currently selected channel and a plurality of other channels that are not currently selected, each of the displayed channels showing moving images corresponding to the content broadcast on the respective channels, wherein channel numbers of the currently selected channel and the plurality of other channels that are not currently selected conform to a predefined pattern;
changing the channel on the video device to select one of the displayed channels that was not previously selected, the newly selected channel becoming the currently selected channel; and
simultaneously displaying the currently selected channel and a plurality of other channels that are not currently selected, wherein the channel numbers of the currently selected channel and the plurality of other channels that are not currently selected conform to the predefined pattern.

2. The method of claim 1, wherein the video device simultaneously displays the currently selected channel and two other channels that are not currently selected, one of the channels that is not currently selected having a lower channel number than the currently selected channel and the other channel that is not currently selected having a higher channel number than the currently selected channel.

3. The method of claim 1, wherein the channel numbers of the currently selected channel and the plurality of other channels that are not currently selected are consecutive numbers.

4. The method of claim 1, further comprising:
confirming selection of the currently selected channel; and
displaying only the currently selected channel on the video device.

5. The method of claim 1, further comprising:
not receiving any input from a user of the video device for a predetermined period of time when simultaneously displaying the currently selected channel and the plurality of other channels that are not currently selected; and
displaying only the currently selected channel on the video device after the predetermined period of time has elapsed.

6. The method of claim 1, wherein when only one channel is displayed on the video device, the channel is displayed in full size, and when more than one channel is displayed on the video device, the channels are simultaneously displayed in smaller sizes.

7. A video device for selecting a television channel, the video device comprising:
a display unit;
a television tuner for displaying television channels on the display unit;
a processor for controlling the television tuner to simultaneously display a currently selected channel and a plurality of other channels that are not currently selected, each of the displayed channels showing moving images corresponding to the content broadcast on the respective channels, wherein channel numbers of the currently selected channel and the plurality of other channels that are not currently selected conform to a predefined pattern; and
a channel selection unit for changing the channel on the video device to select one of the displayed channels that was not previously selected, the newly selected channel becoming the currently selected channel.

8. The video device of claim 7, wherein the processor controls the television tuner to simultaneously display the currently selected channel and two other channels that are not currently selected, one of the channels that is not currently selected having a lower channel number than the currently selected channel and the other channel that is not currently selected having a higher channel number than the currently selected channel.

9. The video device of claim 7, wherein the channel numbers of the currently selected channel and the plurality of other channels that are not currently selected are consecutive numbers.

10. The video device of claim 7, wherein the channel selection unit is used to confirm selection of the currently selected channel, wherein the processor controls the television tuner to accordingly only display the currently selected channel on the display unit.

11. The video device of claim 7, further comprising:
a timer for measuring an amount of time in which the video device does not receive any input from a user of the video device when the processor controls the television tuner to simultaneously display the currently selected channel and the plurality of other channels that are not currently selected;
wherein the processor controls the television tuner to display only the currently selected channel on the video device after a predetermined period of time counted by the timer has elapsed.

12. The video device of claim 7, wherein when only one channel is displayed on the display unit of the video device, the channel is displayed in full size, and when more than one channel is displayed on the display unit of the video device, the channels are simultaneously displayed in smaller sizes.
